(19) United States
(12) Patent Application Publication
(10) Pub. No.: US 2009/0256813 A1
(43) Pub. Date: Oct. 15, 2009

(54) VEHICLE MOVING-IMAGE INTERFACE

(76) Inventors: Alan J. Amici, Rochester Hills, MI (US); Benny J. Oeyen, Bloomfield, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 12/414,723

(22) Filed: Mar. 31, 2009

Related U.S. Application Data
(60) Provisional application No. 61/123,541, filed on Apr. 9, 2008.

(51) Int. Cl. G06F 3/041

(52) U.S. Cl. 345/173

(57) ABSTRACT

A vehicle moving-image interface for displaying and repositioning an image in a plurality of locations in response to a vehicle occupant command includes a display device mounted to the vehicle. The display device has first and second surface portions, with the first surface portion displaying the image. The interface further includes a sensor configured to generate a signal in response to an actuation object contacting the first surface portion and then sliding on the display device toward the second surface portion. The interface further includes a controller configured to receive the signal from the sensor to induce the second surface portion to display the image for repositioning the image on the display device

### CROSS-REFERENCE TO RELATED APPLICATIONS

This application claims the benefit of U.S. Provisional Patent Application Ser. No. 61/123,541 filed Apr. 9, 2008, the disclosure of which is hereby incorporated by reference.

### TECHNICAL FIELD

The disclosure relates generally to vehicle controls and displays, and more particularly to a vehicle moving-image interface having reconfigurable images of controls and displays that may be selectively displayed, repositioned and resized.

### BACKGROUND

Existing vehicle dashboards have controls and displays that remain one size in their respective fixed locations on the dashboard. The displays may include a speedometer, a tachometer, a fuel gauge, a battery gauge, a low fuel light, a low washer fluid light, a security system light and an antilock braking system light. Examples of the controls or actuators may include rotatable dials and pushbuttons for operating a stereo system, a HVAC module, a navigation system and/or other suitable devices.

The speedometer and the tachometer typically are the largest gauges located in fixed positions directly within the driver's forward line of sight. Accordingly, the driver may determine the vehicle speed and engine speed faster than other vehicle information without regard to the driving conditions.

The inventors have herein recognized a need for a vehicle moving-image interface having a reconfigurable display for conspicuously providing vehicle information and access to controls as chosen by vehicle occupants.

### SUMMARY OF THE INVENTION

According to one implementation, a vehicle moving-image interface for displaying and repositioning an image in a plurality of locations in response to a vehicle occupant command includes a display device mounted to the vehicle. The display device has first and second surface portions, with the first surface portion displaying the image. The interface further includes a sensor configured to generate a signal in response to an actuation object contacting the first surface portion and then sliding on the display device toward the second surface portion. The interface further includes a controller configured to receive the signal from the sensor to induce the second surface portion to display the image for repositioning the image on the display device.

According to another implementation, a vehicle moving-image interface for displaying an image having first and second end portions and for resizing the image in response to a vehicle occupant command includes a multi-touch display device mounted to the vehicle for displaying the image having a first size. The multi-touch display device has first and second surface portions displaying the first and second end portions of the image. The interface further includes a sensor configured to generate a signal in response to a pair of actuation objects contacting the first and second surface portions, respectively, and then sliding the pair of actuation objects on the display device in a direction toward each other or another direction away from each other. The interface further includes a controller configured to receive the signal from the sensor to induce the multi-touch display device to display the image being scaled up or down to a second size.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a schematic view of a vehicle dashboard having a vehicle moving-image interface with a display device including a driver-side portion, a center stack portion and a passenger-side portion, in accordance with one exemplary embodiment;

FIG. 2 is a schematic view of a vehicle dashboard having a vehicle moving-image interface with a display device including a driver-side portion and a center stack portion, in accordance with another exemplary embodiment;

FIG. 3 is a schematic view of a vehicle dashboard having a vehicle moving-image interface with a display device including a driver-side portion, in accordance with yet another exemplary embodiment;

FIG. 4 is a plan view of the vehicle dashboard of FIG. 1, illustrating the display device showing a plurality of controls and displays in a default setting;

FIG. 5 is a plan view of the vehicle dashboard of FIG. 4, illustrating the display device being actuated to reposition a navigation map display from a top end portion of the center stack portion to the passenger-side portion;

FIG. 6 is a plan view of the vehicle dashboard of FIG. 4, illustrating the display device being actuated to reposition a navigation map display from a top end portion of the center stack portion to a bottom end portion of the center stack portion; and

FIG. 7 is a schematic view of the display device of FIG. 1, illustrating the display device enlarging an image from a first size to a second size in response to a pair of fingers contacting first and second surface portions of the display device displaying first and second end portions of the image and then sliding those fingers on the display device away from each other.

### DETAILED DESCRIPTION OF EXEMPLARY EMBODIMENTS

The following description of the embodiment(s) is merely exemplary in nature and is in no way intended to limit the invention, its application, or uses.

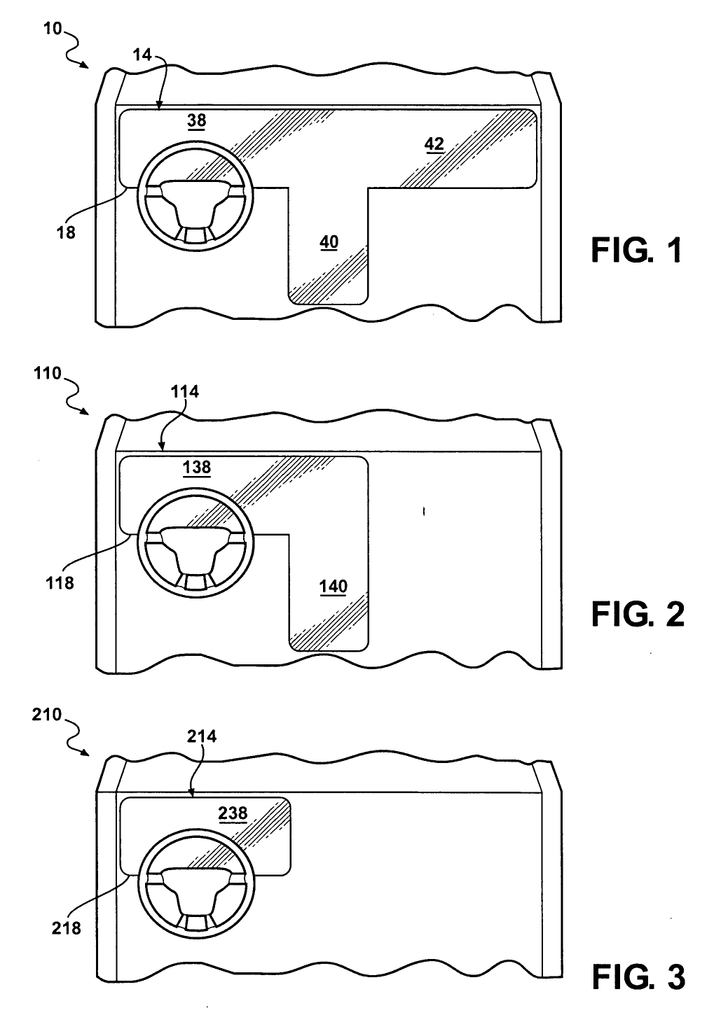

Referring to FIG. 1, a vehicle dashboard 10 may include a panel 12 and a vehicle moving-image interface 14 having a reconfigurable display for conspicuously providing vehicle information and access to controls in a configuration chosen by a vehicle occupant. The interface 14 may include a series of images 16, a multi-touch display device 18, a sensor 20, a controller 22 and one or more push-button switches 24. Each image may be a digital representation of a display gauge or control. The display device 18 may be mounted to the panel 12 and have first and second surface portions 26, 28, with the first surface portion 26 displaying one of the images 16. The sensor 20 may be configured to generate a signal in response to a finger or other suitable actuation object contacting the first surface portion 26 and then sliding on the display device 18 toward the second surface portion 28. The controller 22 may be configured to receive the signal from the sensor 20 to induce the second surface portion 28 to display the image 16 for repositioning the image 16 on the display device 18. Accordingly, the display device 18 may display the image moving along a path from the first surface portion 26 to the second surface portion 28. As detailed below, one example of the push-button switches 24 may include a duplication switch 24.

The panel 12 may be mounted to a vehicle having a first A-pillar portion 30 and a second A-pillar portion 32 opposite the first A-pillar portion 30, such that the panel extends substantially from the first A-pillar portion 30 to the second A-pillar portion 32. It is contemplated that the interface 14 may be associated with various other portions of the vehicle. The panel 12 may have a pair of opposing end portions 34, 36 associated with the first and second A-pillar portions 30, 32, respectively.

The multi-touch display device 18 may be associated with the panel 12, such that the display device 18 extends from one end portion 34 of the panel 12 to the other end portion 36 of the panel 12. This display device may include a driver-side portion 38, a center stack portion 40 and a passenger-side portion 42. The driver-side portion 38 is proximal to the first A-pillar, the center stack portion extends perpendicularly from an end 44 of the driver-side portion 38 opposite the first A-pillar portion 30, and the passenger-side portion extends from the end 44 of the driver-side portion 38 substantially to the second A-pillar portion 32. It is contemplated that the display device 18 may instead extend directly from the first and/or the second A-pillar portions 30, 32, B-pillar portions, first row seatbacks, second row seatbacks, a first row center console, a second row center console, a roof interior, vehicle doors, any panels thereof or any suitable combination thereof.

Referring to FIG. 2, a vehicle moving-image interface 114 having a display device 118 may be substantially similar to the interface 14 of FIG. 1 having the display device 18. However, this display device 118 may not include the passenger-side portion 42.

Further, as shown in the exemplary embodiment of FIG. 3, a vehicle moving-image interface 214 having a display device 218 may be substantially similar to the interface 14 of FIG. 1 having the display device 18. However, this display device 214 may not include the passenger-side portion 42 and the center stack portion 40.

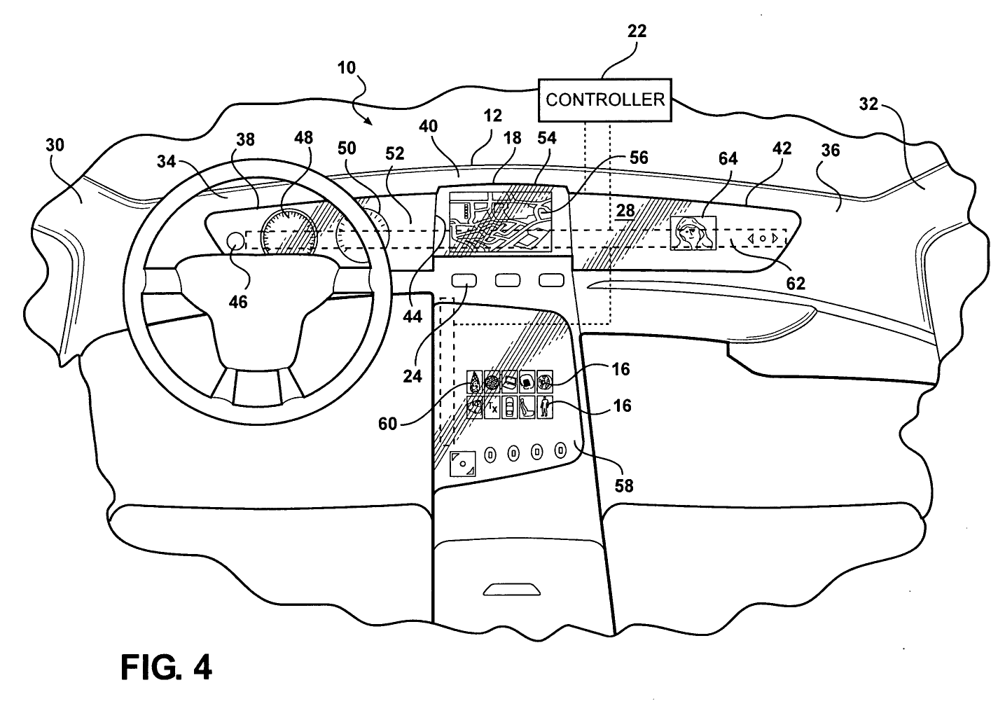

Referring to FIG. 4, there is shown the interface 14 of FIG. 1, illustrating the display device 18 displaying a default setting or configuration of various images indicative of predetermined controls and displays. In this default setting, the driver-side portion 38 may display a first map 46, a tachometer 48, a speedometer 50 and a fuel gauge 52. Further, the center stack portion 40 may have a top portion 54 displaying a second map 56 and a bottom portion 58 displaying media player controls 60 for operating the car stereo and/or displaying a video on the display device 18. The passenger-side portion 42 may display photo viewing application controls 62 and photographs 64 manipulated and/or accessed via the controls 62.

Other examples of display or control images include an oil pressure gauge, a battery gauge, a low washer fluid warning, a low tire profile warning, an anti-lock braking system indicator, an internet web browser and a video player.

The controller 22 may be operably associated with a known vehicle device configured to generate a notification signal. The controller may receive the notification signal from the vehicle device and induce the display device 18 to display an image indicative of an updated vehicle condition based on the notification signal. For instance, the controller 22 may be associated with a fuel level sensor configured to generate a fuel level signal indicative a fuel level in a fuel tank. The controller may receive the fuel level signal from the fuel level sensor and induce the display device 18 to show a fuel gauge image indicative of an updated fuel level based on the fuel level signal. By way of another example, the controller may be associated with a navigation system configured to generate a map signal. The controller may receive the map signal from the navigation system and induce the display device 18 to display a map showing a location of the vehicle based on the map signal.

The controller 22 may be further operably associated with another known vehicle device to control or operate that device. Namely, the sensor 20 may be configured to generate an actuation signal in response to predetermined strokes or other forms of contact being applied to the display device. The controller may receive the actuation signal and induce the display device to display a chosen vehicle setting based on the actuation signal. The controller may be further operably associated with a known vehicle device to actuate the vehicle device based on the actuation signal. By way of example, the sensor may generate an actuation signal in response to a vehicle occupant making applying contact strokes to a portion of the display device showing a volume control. The controller 22 may receive the actuation signal from the sensor and induce a vehicle stereo system to increase or decrease its volume based on the actuation signal.

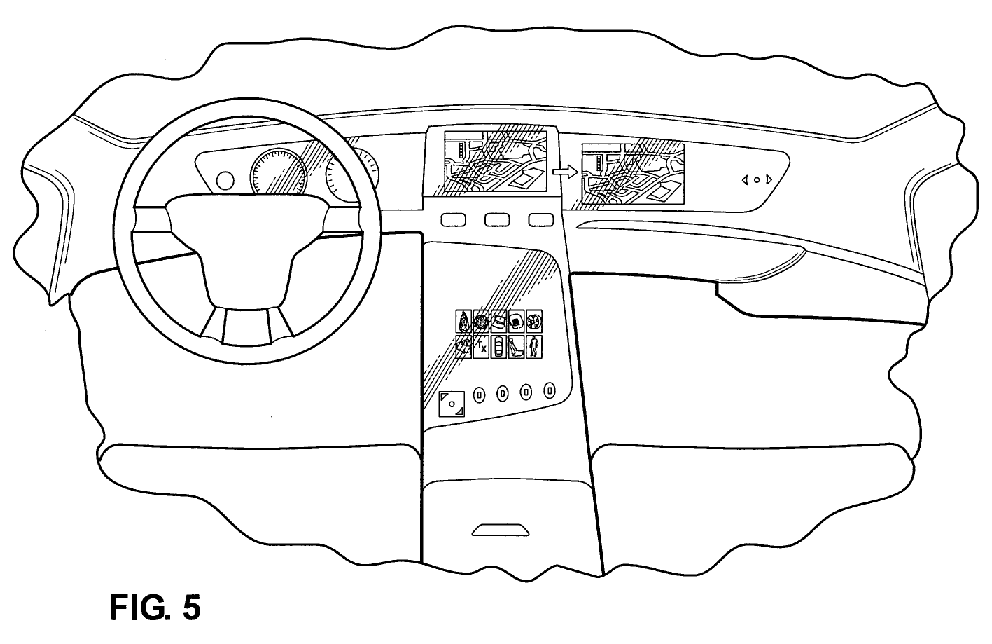

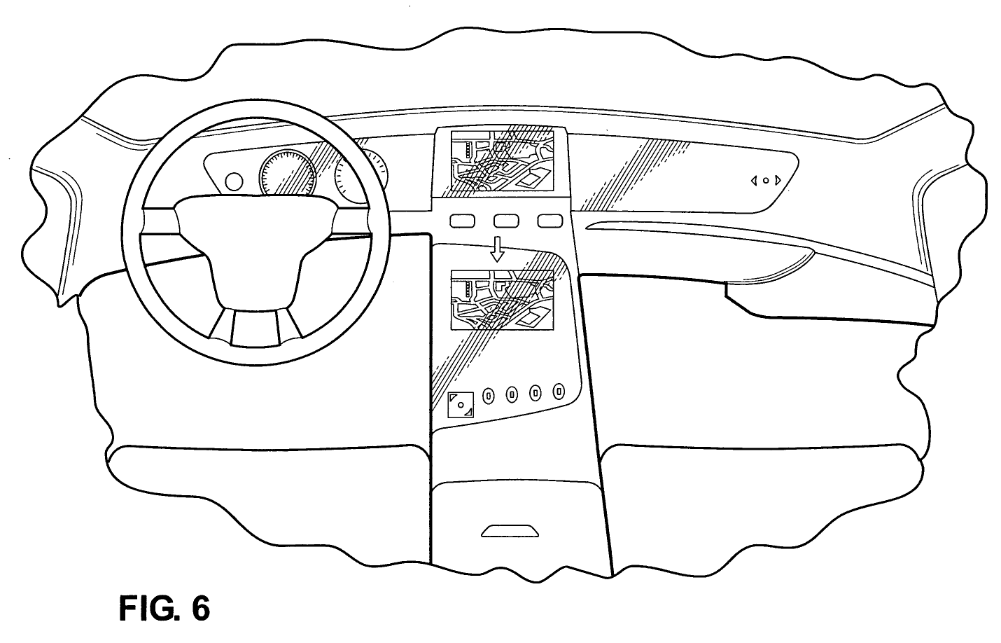

Referring to FIG. 5, the vehicle occupant may reconfigure the interface 14 to reposition an image, e.g. the navigation map, from the top portion 54 of the center stack portion 40 to the passenger-side portion 42. In particular, the sensor may generate a repositioning signal in response to the occupant contacting his finger with the top portion 54 showing the image and then sliding his finger on the display device 18 toward the passenger-side portion 42. The controller may receive the repositioning signal from the sensor and induce the display device 18 to display the navigation map 56 moving along a path from the top portion 54 of the center stack portion 40 to the passenger-side portion 42.

Similarly, referring to FIG. 5, the vehicle occupant may reconfigure the interface 14 to reposition an image, e.g. the navigation map, from the top portion 54 to the bottom portion 58 of the center stack portion 40. In particular, the sensor may generate a repositioning signal in response to the occupant contacting his finger with the top portion 54 showing the image and then sliding his finger on the display device 18 toward the bottom portion 58. The controller may receive the repositioning signal from the sensor and induce the display device 18 to display the navigation map 56 moving along a path from the top portion 54 of the center stack portion 40 to the passenger-side portion 42.

It is contemplated that other suitable images can be repositioned from one surface portion of the display device 18 to other suitable surface portions of the display device 18. However, the controller 22 may be configured to induce a predetermined portion of the display device 18 to display a predetermined image that remains only within that portion of the display device. For example, the controller 22 may be configured to induce only the driver-side portion 38 to display the speedometer 50.

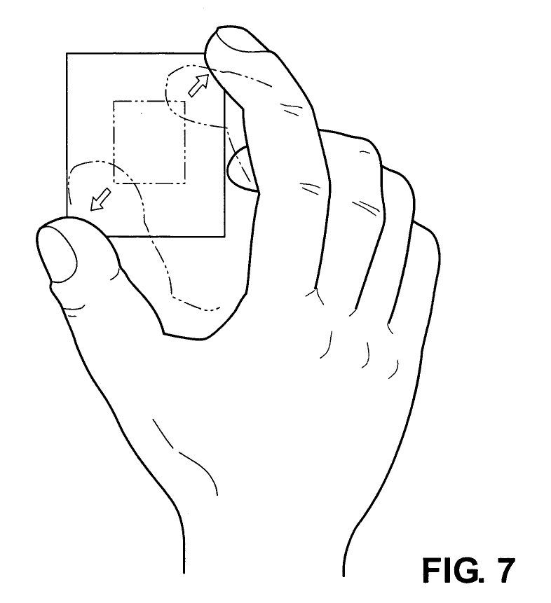

Referring to FIG. 7, the multi-touch display device 18 may be configured to display the image 16 having a first size and resize the image from the first size to a second size in response to a vehicle occupant command. The image may have first and second end portions 66, 68, and the multi-touch display device 18 may have first and second surface portions 26, 28 displaying the first and second end portions of the image. The sensor 20 may be configured to generate a resizing signal in response to a pair of fingers or other suitable actuation objects contacting the first and second surface portions 26, 28, respectively, and then sliding on the display device 18 in a direction toward each other or a direction away from each other. The controller 22 may be configured to receive the resizing signal from the sensor 20 to induce the multi-touch display device 18 to display the image enlarging or shrinking to the second size.

The second size may be larger than the first size, based on the signal being generated in response to the pair of actuation objects sliding on the display device away from each other. Further, the second size may be smaller than the first size, based on the signal being generated in response to the pair of actuation objects sliding on the display device toward each other.

The controller 22 may be further configured to induce the display device to duplicate one or more of the images. For instance, the duplication push-button switch may generate a duplication signal in response to the vehicle occupant pressing the duplication push-button switch. The sensor 20 may generate a selection signal in response to the occupant contacting the first surface portion displaying the image and then sliding toward the second surface portion 28. The controller 22 may receive the duplication and selection signals and induce the display device 18 to display another image that is identical to the image displayed in the first portion, such that the display device shows the duplicate image moving along a path from the first surface portion to the second surface portion. This feature may be beneficial for providing navigation maps to a driver and a front seat passenger, so that each occupant can access and/or operate his respective map. The multi-touch display device and controller may allow each occupant to manipulate, access, reposition, enlarge or close his respective map based on predetermined finger strokes, gestures or other touch-based actuations to the portions of the display device displaying the respective maps.

The controller 22 may be configured to induce the display device to display a variety of settings. For example, the controller may induce the display device to display a sport setting in which the controller 22 induces the driver-side portion of the display device 18 to display a tachometer enlarged from its default setting and centered within the driver-side portion of the display device 18. By way of another example, the controller may induce the display device to display a traveler setting in which the display device 18 stops displaying the tachometer but rather displays navigation maps in one or more portions of the device. It is contemplated that the controller may be configured to display a variety of personal settings with displays and controls sized, positioned, opened or closed as determined by the user. Also, the controller may be configured to induce the display device to display various background settings with various colors and graphics—including sports themes, nature themes, and so forth.

The above description of embodiments of the invention is merely exemplary in nature and, thus, variations thereof are not to be regarded as a departure from the spirit and scope of the invention.

What is claimed is:

1. A vehicle moving-image interface for displaying and repositioning an image in a plurality of locations in response to a vehicle occupant command, comprising:
a display device mounted to the vehicle and having first and second surface portions, the first surface portion displaying the image;
a sensor configured to generate a signal in response to an actuation object contacting the first surface portion and then sliding on the display device toward the second surface portion; and
a controller configured to receive the signal from the sensor to induce the second surface portion to display the image for repositioning the image on the display device.

2. The vehicle moving-image interface of claim 1, wherein the display device displays the image moving from the first surface portion toward the second surface portion.

3. The vehicle moving-image interface of claim 1, wherein the display device includes a driver-side portion proximal to a first A-pillar portion.

4. The vehicle moving-image interface of claim 3, wherein the display device further includes a center stack portion extending perpendicularly from an end of the driver-side portion opposite the first A-pillar portion.

5. The vehicle moving-image interface of claim 3, wherein the display device further includes a passenger-side portion extending from an end of the driver-side portion opposite the first A-pillar portion toward a second A-pillar portion.

6. A vehicle moving-image interface for displaying an image having first and second end portions and for resizing the image in response to a vehicle occupant command, comprising:
a multi-touch display device mounted to the vehicle for displaying the image having a first size, the multi-touch display device having first and second surface portions displaying the first and second end portions of the image;
a sensor configured to generate a signal in response to a pair of actuation objects contacting the first and second surface portions, respectively, and then sliding the pair of actuation objects on the display device in one of a direction toward each other and a direction away from each other; and
a controller configured to receive the signal from the sensor to induce the multi-touch display device to display the image having a second size for resizing the image.

7. The vehicle moving-image interface of claim 6 wherein the second size is larger than the first size, based on the signal being generated in response to the pair of actuation objects sliding away from each other.

8. The vehicle moving-image interface of claim 6 wherein the second size is smaller than the first size, based on the signal being generated in response to the pair of actuation objects sliding toward each other.

9. The vehicle moving-image interface of claim 6, further comprising a navigation system associated with the controller to induce the display device to display the vehicle condition indicative of a location of the vehicle.

10. The vehicle moving-image interface of claim 6, further comprising a stereo system associated with the controller to play at least one of a chosen radio station and a chosen song at a chosen volume in response to the image indicating the chosen vehicle setting.

11. The vehicle moving-image interface of claim 6 wherein the image is indicative of one of a tachometer, a speedometer, a fuel gauge, an oil pressure gauge, a battery gauge, a low washer fluid warning, a low tire profile warning, an anti-lock braking system indicator, a navigation map, a photograph, an internet web browser and a video.
